(19) United States
(12) Patent Application Publication
(10) Pub. No.: US 2007/0191021 A1
(43) Pub. Date: Aug. 16, 2007

(54) Apparatus and methods for information handling system with flexible communication capabilities

(76) Inventors: Thomas Cantwell, Liberty Hill, TX (US); Liam B. Quinn, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/352,723

(22) Filed: Feb. 13, 2006

(51) Int. Cl. H04Q 7/20

(52) U.S. Cl. 455/456.1

(57) ABSTRACT

An information handling system includes a communication apparatus. The communication apparatus includes a wireless device. The wireless device uses, and may be operated according to, a set of operating parameters derived from information about a geographic location.

### TECHNICAL FIELD

The inventive concepts relate generally to information handling apparatus and systems. More particularly, the invention concerns apparatus and associated methods for flexible communication devices that adapt to the characteristics and/or specifications of their operating environments.

### BACKGROUND

As the value and use of information continues to increase, individuals and businesses seek additional ways to process and store information. One option available to users is information handling systems or apparatus. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated.

The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the complexity and functionality of information handling systems and apparatus has grown, the processing of information has tended to become more distributed or networked, resulting a desire for increased communication flexibility. Wireless devices provide a cable-free solution that provides increased communication capability.

The wide-spread use of wireless devices, however, has resulted in difficulties or inconvenience to either or both of the service providers and the users. More specifically, each geographic region tends to prescribe a set of rules or specifications that govern various parameters of wireless operation, such as frequencies of operation and output power. The diversity of the rules or specifications has resulted in manufacturers having to make devices suitable for operation in specific areas and/or users having to configure the devices in order to use the particular parameters for a desired region. A need exists for a more flexible wireless solution capable of relatively easy setup and use in various geographic areas.

### SUMMARY

The disclosed novel concepts relate to apparatus and associated methods for flexible communication devices or circuitry. In one exemplary embodiment, an information handling system includes a communication apparatus. The communication apparatus includes a wireless device. The wireless device uses, and may be operated according to, a set of operating parameters derived from information about a geographic location.

In another exemplary embodiment, a communication apparatus includes a location finding device, a parameter database device, and a wireless device. The parameter database device couples to the location finding device. The wireless device couples to the location finding device. At least one operating parameter of the wireless device (e.g., frequency of operation and/or output power) is derived from information in the parameter database device.

Another exemplary embodiment relates to a method of operating a communication apparatus. The communication apparatus includes a wireless device, such as a receiver, transmitter, transceiver, etc. The method includes obtaining information about a location of the communication apparatus, and deriving a set of at least one operating parameter for the wireless device from the location of the communication apparatus. The method further includes operating the wireless device according to the set of at least one operating parameter for the wireless device.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows a simplified block diagram of a communication apparatus according to an illustrative embodiment of the invention.

FIG. 2 illustrates a simplified block diagram of a communication apparatus according to another illustrative embodiment of the invention.

FIGS. 3A-3C depict simplified block diagrams of wireless circuitry or devices for use in various embodiments according to the invention.

FIG. 4 shows an example of an arrangement of location parameters for use in exemplary embodiments of the invention.

FIG. 5 show a simplified flow diagram for a method of operating a communication apparatus, device, or circuit according to an exemplary embodiment of the invention.

FIG. 6 illustrates a simplified block diagram of an information handling system that includes communication circuitry according to the invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes.

For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory.

Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In exemplary embodiments, the inventive concepts contemplate communication apparatus (or device, circuit, system, etc.) that provide manufacturers and end-users with increased flexibility. More specifically, the apparatus can determine the location of the user or the communication apparatus, and automatically use particular parameters, rules, or specifications that govern the operation of wireless devices at that location.

FIG. 1 shows a simplified block diagram of a communication apparatus 10 according to an illustrative embodiment of the invention. Communication apparatus 10 includes wireless device 15, location finding device 20, parameter database 25, and antenna 30.

Wireless device 15, as described below in detail, may constitute a receiver, transmitter, or transceiver, as desired. Wireless device couples to and communicates with antenna 30. Through wireless device 15, communication apparatus can wirelessly communicate with other systems, users, devices, etc., as desired.

Location finding device 20 finds or detects the location of communication apparatus 10 (or other device, as desired). Location finding device 20 may have a variety of forms, as persons of ordinary skill in the art who have the benefit of the description of the invention understand. In some embodiments, location finding device 20 may constitute global positioning satellite (GPS) circuitry, such as a GPS receiver.

Regardless of its chosen form, location finding device 20 provides location information to parameter database 25 via link 33. Link 33 may include a coupling mechanism, such as a bus, conductors, wires, etc., as persons of ordinary skill in the art who have the benefit of the description of the invention understand.

The location information depends generally on the type/form of location finding device 20. Generally speaking, the location information may constitute any desired information about the location of communication apparatus 10. As one example, the location information may constitute longitude and latitude information that locate or pinpoint a region or location geographically or otherwise, as desired.

Using the location information, parameter database 25 determines a set of parameters for at least some of the various aspects of operation of wireless device 15. Parameter database 25 provides the set of parameters to wireless device 15 via link 36. Link 36 may generally include any suitable or desired coupling mechanism, such as conductors, wires, buses, etc.

Parameter database 25 may constitute a device suitable for storage and manipulation of the parameters. For example, parameter database 25 may reside in a memory, storage device, etc. If desired, one may make parameter database 25 read-only or re-writable. A read-only device would not allow updating of the parameters stored within it, whereas a re-writable device would allow the user or other entity to update the information (for example, in response to changes in the local rules or specifications).

Note that one may restrict the locations or regions within which communication apparatus 10 operates. One may do so by storing appropriate parameters within parameter database 25 that effectively restrict operation (e.g., zero output power for wireless device 15). Alternatively, one may do so by not storing any parameters for that particular location or region, so that communication apparatus 10 fails to operate in a prescribed set of regions or locations.

The set of parameters may include frequency of operation, output power, or both. The set of parameters may also include other information, such as conditions of operation (e.g., permitted time(s) of operation), permitted or specified channels, and the like, as persons of ordinary skill in the art who have the benefit of the description of the invention understand.

Wireless device 15 uses the set of parameters in order to operate in a manner suitable, desired, or prescribed for the geographic location of communication apparatus 10. More specifically, wireless device 15 operates with a particular set of operational parameters that meet the rules or specifications for a particular geographic location.

For example, wireless device 15 may use a prescribed frequency in order to communicate with a remote device or user. As another example, wireless device 15 may operate (transmit) using a prescribed output power in order to communicate with a remote device or user. By using the set of parameters pertinent or particular to the desired geographic location, wireless device 15 operates in a manner that meets the rules or specifications for that particular location.

Note that, in contrast to conventional approaches, the manufacturer of communication apparatus 10 need not program, make, or configure it for operation in a particular geographic location. Rather, the manufacturer manufacturers communication apparatus 10 with a general configuration or architecture. During operation, communication apparatus 10 can determine the particular region or location in which it operates, extract the appropriate parameters for wireless or radio operation in that region or location, and operate so as to meet the rules or specifications for that region or location.

Similarly, note that the user need not configure the operation of communication apparatus 10 in order to conform to local rules or specifications for a particular region or location. Rather, as described, communication apparatus may perform that task. Thus, communication apparatus 10 can be manufactured in a flexible manner, and can operate in a flexible, automatic manner, with reduced or no inconvenience to the user.

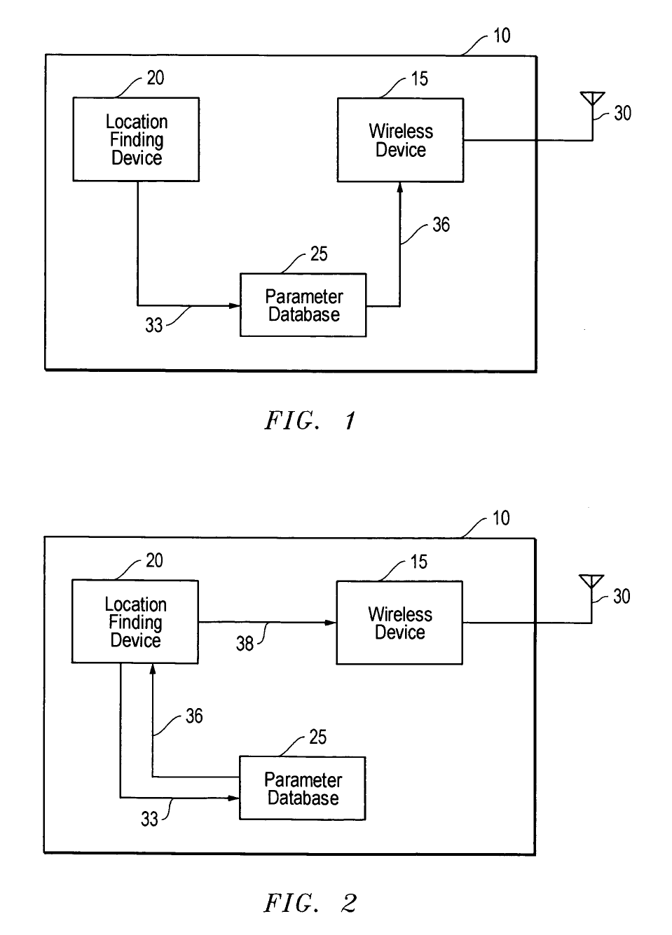

FIG. 2 illustrates a simplified block diagram of a communication apparatus 10 according to another illustrative embodiment of the invention. Communication apparatus 10 includes wireless device 15, location finding device 20, parameter database 25, and antenna 30. Except as noted, wireless device 15, link 33, and location finding device 20 perform the same or similar functions and may have the same or similar circuitry as their counterparts in the embodiment shown in FIG. 1.

Note that, unlike the embodiment in FIG. 1, parameter database 25 provides the set of parameters to location finding device. In some embodiments, parameter database 25 may constitute part of location finding device 20, as desired. For example, parameter database 25 might constitute part of a module, or a card that the user or the manufacturer can readily replace or select from a range of options and varieties, as desired.

Location finding device 20 provides location information to parameter database 25 via link 33. The location information may have characteristics and contents described above.

Using the location information, parameter database 25 determines a set of parameters for at least some of the various aspects of operation of wireless device 15. Parameter database 25 provides the set of parameters to location finding device 20 via link 36. Link 36 may generally include any suitable or desired coupling mechanism, such as conductors, wires, buses, etc.

Parameter database 25 may constitute a device suitable for storage and manipulation of the parameters, as described above, and as desired. Note that, similar to the embodiment shown in FIG. 1, one may restrict the locations or regions within which communication apparatus 10 operates, as desired. Furthermore, the set of parameters may be similar to the parameters described in connection with FIG. 1, as desired.

Location finding device 20 provides the set of parameters to wireless device 15 via link 38. Link 38 may constitute any suitable or desired coupling mechanism, such as conductors, wires, buses, etc. As noted above, wireless device 15 uses the set of parameters in order to operate in a manner suitable, desired, or prescribed for the geographic location of communication apparatus 10. Thus, similar to the embodiment in FIG. 1, communication apparatus 10 can be manufactured in a flexible manner, and can operate in a flexible, automatic manner, with reduced or no inconvenience to the user.

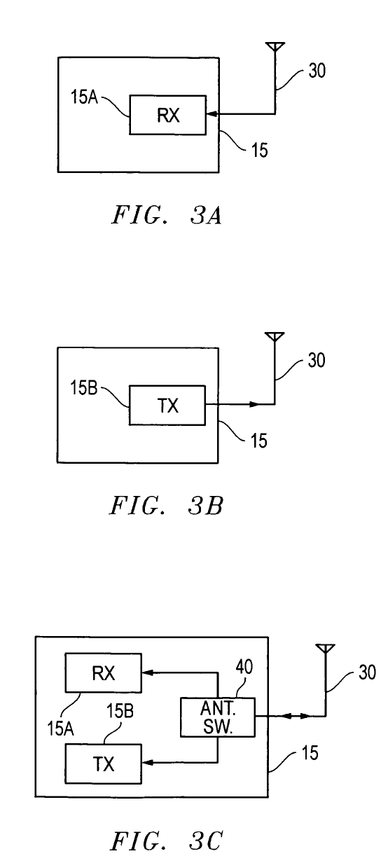

FIGS. 3A-3C depict simplified block diagrams of wireless device 15 for use in various embodiments according to the invention. In the embodiment in FIG. 3A, wireless device 15 constitutes a receiver. Thus, wireless device 15 includes receiver circuit 15A. Using receiver circuit 15A, wireless device 15 can receive signals within desired or prescribed geographical locations, using appropriate parameters (e.g., frequency).

Conversely, in the embodiment in FIG. 3B, wireless device 15 constitutes a transmitter. Accordingly, wireless device 15 includes transmitter circuit 15B. Using transmitter circuit 15B, wireless device 15 can transmit signals within desired or prescribed geographical locations, using appropriate parameters (e.g., frequency and/or output power).

In the embodiment in FIG. 3C, wireless device 15 constitutes a transceiver. Accordingly, wireless device 15 includes receiver circuit 15A and transmitter circuit 15B. Note that, as persons of ordinary skill in the art who have the benefit of the description of the invention understand, the receiver and transmitter circuits may constitute separate blocks of circuitry or may use or share common circuitry, as desired.

Using receiver circuit 15A, wireless device 15 can receive signals within desired or prescribed geographical locations, using appropriate parameters (e.g., frequency). Moreover, using transmitter circuit 15B, wireless device 15 can transmit signals within desired or prescribed geographical locations, using appropriate parameters (e.g., frequency and/or output power).

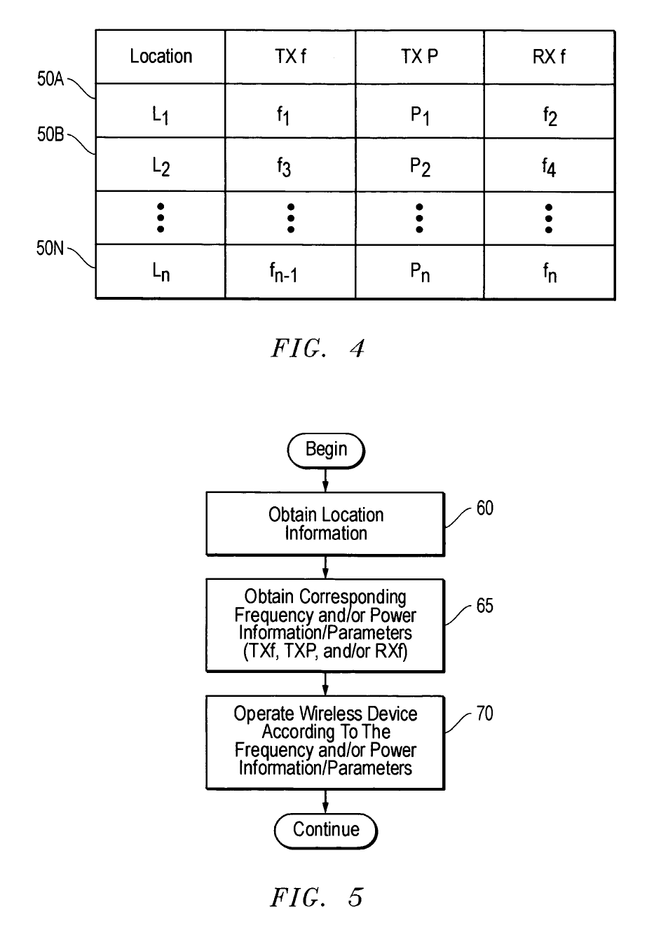

FIG. 4 shows an example of an arrangement of location parameters for use in exemplary embodiments of the invention. One may use the shown arrangement as data structures within parameter database 25, as desired.

The arrangement in FIG. 4 organizes the parameter information as a table (or array or list). The arrangement includes information for locations L1 through Ln, denoted as rows 50A-50N. For each location, depending on the desired functionality of wireless device 15, the parameter information may include various fields of data.

For example, for transmitter or transceiver operation, the data may include transmit frequency (TX f) and/or transmit output power (TX P). For receiver or transceiver operation, the data may include receiver frequency (RX f).

Note that one may include more than one set of parameters for a given location, as desired. For example, a given location may allow or prescribe more than one set of frequencies and/or output powers. Communication apparatus 10 may use the multiple parameters in a number of ways, as persons of ordinary skill in the art who have the benefit of the description of the invention understand. For instance, during operation, communication apparatus may use a default or preferred set of parameters, or present a set of choices of parameters to the user and allow the user to select the desired parameters. As another example, communication apparatus 10 may select and use parameters based on various factors, such as signal quality, presence of interference, etc.

FIG. 5 show a simplified flow diagram for a method of operating a communication apparatus, device, or circuit according to an exemplary embodiment of the invention. The operation begins at 60, where the communication apparatus obtains location information. At 65, corresponding parameters or information (e.g., frequency and/or output power) are obtained, using suitable techniques, such as those described above.

At 70, a wireless device is operated according to the parameters or information obtained at 65. Thus, as described above in detail, one may operate one or more of a receiver, a transmitter, and a transceiver, as desired.

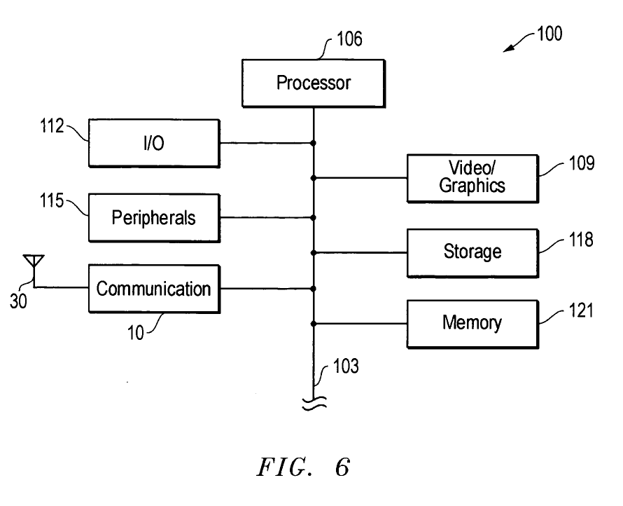

FIG. 6 shows a simplified block diagram of an information handling system 100 according to an exemplary embodiment of the invention. Generally speaking, system 100 may constitute a host or server computer system, workstation, PDA, mobile telephone, handheld device, and the like, as desired. System 100 includes one or more processors 106, one or more buses or communication media 103, video/graphics hardware 109, storage subsystem 118, memory 121, input/output (I/O) 112, peripherals 115, and communication apparatus 10 (described above in detail).

Bus 103 provides a mechanism for the various components of system 100 to communication and couple with one another and thus acts as the backbone of the system. Processor 106, video/graphics 109, storage subsystem 118, memory 121, I/O 112, and peripherals 115 have the structure, and perform the functions, familiar to persons of ordinary skill in the art who have the benefit of the description of the invention.

Communication apparatus 10 may communicate with one or more of the blocks or circuits in system 100, as desired. Through communication apparatus 10, the user may communicate with other systems, users, or communication devices (such as access points, transceivers, receivers, transmitters, and the like), as desired. The forms, protocols, and other details of the communication may take place in a variety of ways, as persons of ordinary skill in the art who have the benefit of the description of the invention understand.

Referring to the figures, persons of ordinary skill in the art will note that the various blocks shown may depict mainly the conceptual functions and signal flow. The actual circuit implementation may or may not contain separately identifiable hardware for the various functional blocks and may or may not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. An information handling system, comprising a communication apparatus comprising a wireless device, wherein the wireless device uses a set of operating parameters derived from information about a geographic location.

2. The information handling system according to claim 1, wherein the geographic location comprises a location of communication apparatus.

3. The information handling system according to claim 1, wherein the wireless device comprises a receiver.

4. The information handling system according to claim 3, wherein the set of operating parameters comprises a receive frequency.

5. The information handling system according to claim 1, wherein the wireless device comprises a transmitter.

6. The information handling system according to claim 5, wherein the set of operating parameters comprises a transmit frequency, an output power, or both.

7. The information handling system according to claim 1, wherein the wireless device comprises a transceiver.

8. The information handling system according to claim 7, wherein the set of operating parameters comprises a receive frequency, a transmit frequency, and/or output power.

9. A communication apparatus, comprising:
a location finding device;
a parameter database device coupled to the location finding device; and
a wireless device coupled to the location finding device,
wherein at least one operating parameter of the wireless device is derived from information in the parameter database device.

10. The communication apparatus according to claim 9, wherein the location finding device comprises a global positioning satellite (GPS) receiver.

11. The communication apparatus according to claim 10, wherein the wireless device comprises a receiver, and wherein at least one operating parameter of the receiver comprises a receive frequency for a geographic location of the GPS receiver.

12. The communication apparatus according to claim 10, wherein the wireless device comprises a transmitter, and wherein at least one operating parameter of the transmitter comprises a transmit frequency, an output power, or both, for a geographic location of the GPS receiver.

13. The communication apparatus according to claim 10, wherein the wireless device comprises a transceiver, and wherein at least one operating parameter of the transceiver comprises a receive frequency, a transmit frequency, and/or an output power, for a geographic location of the GPS receiver.

14. The communication apparatus according to claim 10, wherein information in the parameter database device comprises latitude and longitude information.

15. A method of operating a communication apparatus comprising a wireless device, the method comprising:
obtaining information about a location of the communication apparatus;
deriving a set of at least one operating parameter for the wireless device from the location of the communication apparatus; and
operating the wireless device according to the set of at least one operating parameter for the wireless device.

16. The method according to claim 15, wherein obtaining information about a location of the communication apparatus further comprises using a global positioning satellite (GPS).

17. The method according to claim 15, wherein deriving a set of at least one operating parameter for the wireless device from the location of the communication apparatus comprises using a longitude and a latitude of the location of the communication apparatus.

18. The method according to claim 15, operating the wireless device according to the set of at least one operating parameter for the wireless device further comprises restricting an operation of the wireless device depending on the location of the communication apparatus.

19. The method according to claim 15, wherein the set of at least one operating parameter for the wireless device comprises a frequency.

20. The method according to claim 15, wherein the set of at least one operating parameter for the wireless device comprises an output power.
